(19) United States
(12) Patent Application Publication
(10) Pub. No.: US 2025/0072413 A1
(43) Pub. Date: Mar. 6, 2025

(54) TARGETED WEED CONTROL SPRAYING

(71) Applicant: BASF SE, Ludwigshafen (DE)

(72) Inventors: Anja SIMON, Limburgerhof (DE); Tobias SCHWABEN, Limburgcrhof (DE); Christian POPP, Limburgerhof (DE); Ingo MEINERS, Durham, NC (US); Michael KRAPP, Limburgerhof (DE); Marcel Patrik KIENLE, Limburgerhof (DE)

(21) Appl. No.: 18/722,390

(22) PCT Filed: Dec. 21, 2022
(86) PCT No.: PCT/EP2022/087282

§ 371 Date: Jun. 20, 2024

(30) Foreign Application Priority Data
Dec. 23, 2021 (EP) 21217453.6

(51) Int. Cl. A01M 21/04; A01M 7/00

(52) U.S. Cl. CPC A01M 21/043; A01M 7/0089

(57) ABSTRACT

A computer-implemented method for selectively applying at least one crop protection product onto an agricultural field (40), comprising the following steps: —providing image data of at least a part of an agricultural field (40) which is to be treated with a crop protection product; —providing a crop planting row identification model (63) configured to identify crop planting rows (42) in the image data of the at least one part of the agricultural field (40); —providing a weed plant detection model (65) configured to detect weed plants (46) between the identified crop planting rows (42); —providing a crop and weed detection model (67) configured to detect crop plants (41) and weed plants (46) in the identified crop planting rows (42); —applying a first crop protection product (44) onto a weed plant (46) detected between the identified crop planting rows (42); —applying the first crop protection product (44) onto a weed plant (46) detected in the identified crop planting rows (42), if a distance between the weed plant and an adjacent crop plant is larger than a dynamic determined rows minimal distance.

### TECHNICAL FIELD

The present disclosure relates to a computer-implemented method for selectively applying at least one crop protection product onto an agricultural field, a system for selectively applying at least one crop protection product onto an agricultural field, an application device for selectively applying at least one crop protection product onto an agricultural field, a use of control data for an application device, and a computer program element.

### TECHNICAL BACKGROUND

The general background of this disclosure is the treatment of plants in an agricultural field, which may be an agricultural field, a greenhouse, or the like. The treatment of plants, such as the cultivated crops, may also comprise the treatment of weed plants being present on the agricultural field.

In common agricultural practice, herbicides are applied in pre-emergence, post-emergence or a combination of both conditions. Recent advances in spray application technology allow species-specific applications that allow zone- or plant specific applications. In conventional applications there is no differentiation between crop plants and weeds, the whole field is treated with the respective herbicide or mixtures thereof, and with the respective application rate.

It has been found that a need exists for an alternative and smarter way of spraying crop protection products. Through precise application of crop protection products, only where it is needed, crop plants can be protected more specifically and weeds can be controlled more selectively on an agricultural field, beyond the use of only using selective herbicides, traits or banding applications. Through precise application adverse effects on the crops can be prevented.

### SUMMARY OF THE INVENTION

In one aspect of the present disclosure a computer-implemented method for selectively applying at least one crop protection product, in particular herbicides, onto an agricultural field, comprises the following steps:
providing image data of at least a part of an agricultural field which is to be treated with a crop protection product;
providing a crop planting row identification model configured to identify crop planting rows in the image data of the at least one part of the agricultural field;
providing a weed plant detection model configured to detect weed plants between the identified crop planting rows;
providing a crop and weed detection model configured to detect crop plants and weed plants in the identified crop planting rows;
applying a first crop protection product onto a weed plant detected between the identified crop planting rows;
applying the first crop protection product onto a weed plant detected in the identified crop planting rows, if a distance between the weed plant and an adjacent crop plant is larger than a dynamic determined minimal distance.

In a further aspect of the present disclosure, a system for selectively applying at least one crop protection product onto an agricultural field, comprises:
a receiving unit configured to receive image data of at least a part of an agricultural field which is to be treated with a crop protection product, in particular herbicides;
a first providing unit configured to provide a crop planting row identification model configured to identify crop planting rows in the image data of the at least one part of the agricultural field;
a second providing unit configured to provide a weed plant detection model configured to detect weed plants between the identified crop planting rows;
a third providing unit configured to provide a crop and weed detection model configured to detect crop plants and weed plants in the identified crop planting rows;
a first application unit configured to apply a first crop protection product onto a weed plant detected between the identified crop planting rows;
a second application unit configured to apply the first crop protection product onto a weed plant detected within the identified crop planting rows, if a distance between the weed plant and an adjacent crop plant is larger than a dynamic determined minimal distance.

In a further aspect, an application device for selectively applying at least one crop protection product, in particular herbicides, onto an agricultural field controlled by control data being provided by the method disclosed herein is presented. As used herein, the term “selectively applying” preferably means “applying in a specific way based on the distance between the weed plant and an adjacent crop plant”.

In a further aspect, an use of control data obtained by the method disclosed herein for operating an application device is presented.

In a further aspect a computer element, in particular a computer program product or a computer readable medium, with instructions, which when executed on computing device(s) is configured to carry out the steps of any of the method disclosed herein in a system disclosed herein is presented.

Any disclosure and embodiments described herein relate to the method, the system, the treatment device, the computer program element lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”.

The method, system, application device and computer element disclosed herein provide an efficient, sustainable and robust way for protecting crops on an agricultural field. In particular, the efficient, sustainable, and robust protection of crops can be provided by an image data based identification of and image data based differentiation between crop and weeds and by a precise application of crop protection products by the use of spray technology based on artificial intelligence, either ground or aerial sprayed. Therefore, selective treatment of only weeds can be provided, wherein the crop will be left out, such that the use of non-selective herbicides and the use of placement selectivity is enabled and crop damage or injury can be efficiently prevented. Further, by the distinction between “in the identified crop planting rows” and “between the identified crop rows”, the necessary computational effort can be kept in a manageable range, since “between the identified crop rows” no detection of crop plants and determination of a distance to a weed plant has to take place. Therefore a more computationally intensive procedure can only be carried out for the “in the identified crop planting row”.

It is an object of the present invention to provide an efficient, sustainable and robust way of protecting crops on an agricultural field. These and other objects, which become apparent upon reading the following description, are solved by the subject matters of the independent claims. The dependent claims refer to preferred embodiments of the invention.

The crop protection product is to be understood broadly in the present case and comprises any object or material being useful for the protection of crop. In the context of the present invention, the term crop protection product is specifically dedicated to herbicides but is not limited to. It could also include but is not limited to:
chemical products such as fungicide, insecticide, acaricide, molluscicide, nematicide, avicide, piscicide, rodenticide, repellant, bactericide, biocide, plant growth regulators, fertilizers, pheromones or any combination thereof.
biological products such as microorganisms and extracts thereof or RNAi useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, or any combination thereof.

Herbicides can specifically be referred to as selective or non-selective herbicides. A selective herbicide controls specific weed species, while leaving the desired crop relatively unharmed. In other words, selective herbicides are herbicides that are used to control and kill weeds that grow in fields without damaging the main crop. Specifically, the selective herbicides control or suppress certain plants without affecting the growth of other plants species, i.e. main crop. Selectivity may be due to different translocation behaviour, differential absorption, physical (morphological) or physiological differences between plant species. Selective herbicides in one specific crop may become non-selective when they are applied in another crop. Selectivity may also be dependent on growth stage and placement (e.g. pre-emergence selectivity vs. post-emergence selectivity). Exemplary, selective herbicides in pre-emergence might become non-selective when used in post-emergence to the crop corn, e.g. KIXOR or TIREXOR, but is not limited thereto. In contrast, a non-selective herbicides, e.g. called total weedkillers, kill all plant material with which they come into contact with. In other words, non-selective herbicides are not selective about which plants they kill, i.e. any green plant that they contact will be injured or killed, however due to e.g. metabilization in plants, the level of control might be different from plant to plant. The level of weed control (or ornamental plant injury) resulting from these herbicides depends upon the chemical characteristics, mode of action of the herbicide, and the season of application. Non-selective herbicides may become selective in a crop that has been made tolerant to the chemistry. Exemplary, non-selective herbicides may be GLUFOSINATE-AMMONIUM, GLYPHOSATE (K, IPA) but is not limited thereto. For instance, relevant herbicidal active ingredients & mixtures are the following substances, wherein the order of the substances indicates the relevance of these substances. Exemplary, most relevant herbicides may be Kixor (saflufenacil), Tirexor (trifludimoxazin), Glufosinate-ammonium, L-Glufosinate, Glyphosate-salts, Dicamba and mixtures of at least two of them, but are not limited thereto.

Herbicidal active ingredients & mixtures having a slightly reduced relevance may be 2.4-D (choline, DMA, esters), DICAMBA (BAPMA, DGA, NA, K), ACETOCHLOR, ATRAZINE, BENTAZONE, BICYCLOPYRONE, CARFENTRAZONE-E, CLETHODIM, CLOMAZONE, CLOPYRALID, CLORANSULAM, DFFP, DIMETHENAMID-p, FLUMIOXAZIN, FOMESAFEN, GLUFOSINATE-AMMONIUM, GLYPHOSATE (K, IPA), GLYPHOSATE-POTASSIUM-SALT, IMAZAMOX, IMAZETHAPYR, ISOXAFLUTOLE, MESOTRIONE, METRIBUZIN, PENDIMETHALIN, PYROXASULFONE, QUIZALOFOP, SAFLUFENACIL, S-METOLACHLOR, SULFENTRAZONE, TEMBOTRIONE, TOPRAMEZONE, TRIFLUDIMOXAZIN, METAZACHLOR, CHLORTOLURON, MCPA, PINOXADEN, TRIBENURON-M, DIFLUFENICAN, CLETHODIM, DIQUAT, FLORASULAM, L-GLUFOSINATE AMMONIUM/DMTA-p, DIMETHENAMID-P/TOPRAMEZONE, FLUMIOXAZIN/PYROXASULFONE, GLYPHOSATE/METOLACHLOR, GLYPHOSATE/SAFLUFENACIL, ATRAZINE/S-METOLACHLOR, DIMETHENAMID-P/SAFLUFENACIL, ACETOCHLOR/FOMESAFEN, GLY+GFA, L-GLUFOSINATE AMMONIUM/ACETOCHLOR, ATRAZINE/MESOTRIONE, L-GLUFOSINATE AMMONIUM/TRIFLUDIMOXAZIN/SAFLUFENACIL, FOMESAFEN/GLYPHOSATE, 2.4-D-CHOLINE/GLYPHOSATE, ACETOCHLOR/CLOPYRALID/MESOTRIONE, DICAMBA/DIFLUFENZOPYR, CYPROSULFAMIDE/ISOXAFLUTOLE/THIENCARBAZONE-M, IMAZETHAPYR/PYROXASULFONE/SAFLUFENACIL, ATRAZINE/BICYCLOPYRONE/MESOTRIONE/S-METOLACHLOR, GLYPHOSATE+dicamba, DICAMBA-DIGLYCOLAMINE-SALT/S-METOLACHLOR, GLYPHOSATE/MESOTRIONE, IMAZETHAPYR/SULFENTRAZONE, GLYPHOSATE/MESOTRIONE/S-METOLACHLOR, METRIBUZIN/S-METOLACHLOR, ACETOCHLOR/ATRAZINE, ACETOCHLOR/CLOPYRALID/FLUMETSULAM, S-METOLACHLOR/SULFENTRAZONE, BICYCLOPYRONE/MESOTRIONE/S-METOLACHLOR, FOMESAFEN/S-METOLACHLOR, ACETOCHLOR/MESOTRIONE, 2,4-D CHOLINE/L-GLUFOSINATE AMMONIUM, CLORANSULAM-M/SULFENTRAZONE, ISOXADIFEN-E/TEMBOTRIONE, GLUFOSINATE/PYROXASULFONE/IMAZAMOX, SAFLUFENACIL/TRIFLUDIMOXAZIN, GLUFOSINATE AMMONIUM/ACETOCHLOR, GLUFOSINATE AMMONIUM/S-METOLACHLOR, GLUFOSINATE AMMONIUM/DMTA-p, GLUFOSINATE AMMONIUM/SAFLUFENACIL, GLUFOSINATE AMMONIUM/TRIFLUDIMOXAZIN/SAFLUFENACIL, 2,4-D CHOLINE/GLUFOSINATE AMMONIUM, GA+PYROXASULFONE, GLUFOSINATE+PYROXASULFONE+IMAZAMOX, L-GLUFOSINATE+DMTA-p, PYROXASULFONE+SAFLUFENACIL, PYROXASULFONE+PICOLINAFEN, PYROXASULFONE+DIMETHENAMID, PYROXASULFONE+IMAZETHAPYR, PYROXASULFONE+SAFLUFENACIL+IMAZETHAPYR, PYROXASULFONE+SAFLUFENACIL+MESOTRIONE, DICAMBA+DFFP+PYROX, DICAMBA+PYROX+IMAZETHAPYR, SAFLUFENACIL+TRIFLUDIMOXAZIN+PYROXASULFONE+IMAZETHAPYR, PYROXASULFON+IMAZETHAPYR, DICAMBA+DFFP, but is not limited thereto. Exemplary, non selective herbicides and mixtures thereof may be in a post-emergence application (except to HT crops) SAFLUFENACIL+TRIFLUDIMOXAZIN+PYROXASULFONE+IMAZETHAPYR, GLUFOSINATE/PYROXASULFONE/IMAZAMOX, SAFLUFENACIL/TRIFLUDIMOXAZIN, GLUFOSINATE AMMONIUM/ACETOCHLOR, GLUFOSINATE AMMONIUM/S-METOLACHLOR, GLUFOSINATE AMMONIUM/DMTA-p, GLUFOSINATE AMMONIUM/SAFLUFENACIL, GLUFOSINATE AMMONIUM/TRIFLUDIMOXAZIN/SAFLUFENACIL, 2,4-D CHOLINE/GLUFOSINATE AMMONIUM, GLUFOSINATE+PYROXASULFONE, GLUFOSINATE+PYROXASULFONE+IMAZAMOX, L-GLUFOSINATE+DMTA-p, 2,4-D CHOLINE/L-GLUFOSINATE AMMONIUM, GLYPHOSATE/MESOTRIONE/S-METOLACHLOR, GLYPHOSATE/MESOTRIONE, GLYPHOSATE+dicamba, 2.4-D-CHOLINE/GLYPHOSATE, FOMESAFEN/GLYPHOSATE, L-GLUFOSINATE AMMONIUM/TRIFLUDIMOXAZIN/SAFLUFENACIL, L-GLUFOSINATE AMMONIUM/ACETOCHLOR, GLYPHOSATE+GLUFOSINATE, GLYPHOSATE/SAFLUFENACIL, GLYPHOSATE/METOLACHLOR, L-GLUFOSINATE AMMONIUM/DMTA-p, TRIFLUDIMOXAZIN, GLYPHOSATE-POTASSIUM-SALT, GLYPHOSATE (K, IPA), GLUFOSINATE-AMMONIUM, 2.4-D (choline, DMA, esters), and DICAMBA (BAPMA, DGA, NA, K).

Exemplary, selective herbicides (e.g. for corn) and mixtures thereof may be in a pre- or post-emergence application ACETOCHLOR, ATRAZINE, BENTAZONE, DIMETHENAMID-p, ISOXAFLUTOLE, MESOTRIONE, PYROXASULFONE, SAFLUFENACIL, S-METOLACHLOR, TEMBOTRIONE, TOPRAMEZONE, METAZACHLOR, DIMETHENAMID-P/TOPRAMEZONE, ATRAZINE/S-METOLACHLOR, DIMETHENAMID-P/SAFLUFENACIL, ATRAZINE/MESOTRIONE, ACETOCHLOR/CLOPYRALID/MESOTRIONE, DICAMBA/DIFLUFENZOPYR, ATRAZINE/BICYCLOPYRONE/MESOTRIONE/S-METOLACHLOR, DICAMBA-DIGLYCOLAMINE-SALT/S-METOLACHLOR, ACETOCHLOR/ATRAZINE, BICYCLOPYRONE/MESOTRIONE/S-METOLACHLOR, ACETOCHLOR/MESOTRIONE, ISOXADIFEN-E/TEMBOTRIONE, DICAMBA+DFFP.

Herbicides having a more reduced relevance may be CHLORIMURON-E, DIFLUFENICAN, DIQUAT, FLUFENACET, FLUMETSULAM, FLUTHIACET, HALAUXIFEN, HALOSULFURON, LACTOFEN, PARAQUAT, RIMSULFURON, THIFENSULFURON, TOLPYRALATE, QUIZALOFOP-P-E, FENOXAPROP, FLUROCHLORIDONE, ACLONIFEN, PROPAQUIZAFOP, L-GLUFOSINATE AMMONIUM/TOPRAMEZONE, L-GLUFOSINATE AMMONIUM/MESOTRIONE, ATRAZINE/MESOTRIONE/S-METOLACHLOR, FLUTHIACET-M/PYROXASULFONE, L-GLUFOSINATE AMMONIUM/TEMBOTRIONE, TEMBOTRIONE/THIENCARBAZONE-M, ISOXAFLUTOLE/THIENCARBAZONE-M, L-GLUFOSINATE AMMONIUM/SAFLUFENACIL, IMAZETHAPYR/SAFLUFENACIL, L-GLUFOSINATE AMMONIUM/TRIFLUDIMOXAZIN, DICAMBA BAPMA salt/L-GLUFOSINATE AMMONIUM, GLYPHOSATE/SAFLUFENACIL/FLUDIMOXAZIN, FLUFENACET/ISOXADIFEN-E/TEMBOTRIONE/TERBUTHYLAZINE, DIMETHENAMID-P/METAZACHLOR/QUINMERAC, CLOQUINTOCET-MEXYL/FLORASULAM/PYROXSULAM, METAZACHLOR/QUINMERAC, FLUFENACET/PENDIMETHALIN, IMAZAMOX/IMAZAPYR, DIFLUFENICAN/FLUFENACET/FLURTAMONE, FLORASULAM/PYROXSULAM, AMINOPYRALID/PROPYZAMIDE, METSULFURON-M/TRIBENURON-M, 2.4-D/FLORASULAM, DIFLUFENICAN/FLUFENACET, FLORASULAM/TRITOSULFURON, DIFLUFENICAN/FLORASULAM/PENOXSULAM, CHLORTOLURON/DIFLUFENICAN, IODOSULFURON-M-NA/MESOSULFURON-M, IODOSULFURON-M-NA/MEFENPYR-DIETHYL/MESOSULFURON-M, AMINOPYRALID/CLOPYRALID/PICLORAM, THIFENSULFURON-M/TRIBENURON-M, but is not limited thereto.

Such a herbicide may be at least one of the following, but is not limited thereto: acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Further, a herbicide may be, but are not limited therto, lipid biosynthesis inhibitors, acetolactate synthase inhibitors (ALS inhibitors), photosynthesis inhibitors, protoporphyrinogen-IX oxidase inhibitors, bleacher herbicides, enolpyruvyl shikimate 3-phosphate synthase inhibitors (EPSP inhibitors), glutamine synthetase inhibitors, 7,8-dihydropteroate synthase inhibitors (DHP inhibitors), mitosis inhibitors, inhibitors of the synthesis of very long chain fatty acids (VLCFA inhibitors), cellulose biosynthesis inhibitors, decoupler herbicides, auxinic herbicides, auxin transport inhibitors, and/or other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane, and their agriculturally acceptable salts, amides, esters or thioesters.

As used herein, the term “species” is not meant in the strict biological sense, but comprises the biological class, biological subclass, biological family, biological genus, biological species, biological subspecies, and biological variant (including genetic or epigenetic variant).

The term agricultural field as used herein refers to an agricultural field to be treated. The agricultural field may be any plant or crop cultivation area, such as a farming field, a greenhouse, or the like. A plant may be a crop, a weed, a volunteer plant(a crop from a previous growing season), a beneficial plant or any other plant present on the agricultural field. The agricultural field may be identified through its geographical location or geo-referenced location data. A reference coordinate, a size and/or a shape may be used to further specify the agricultural field.

The term crop planting row as used herein refers to an conventional arrangement of crop plants on a cultivation area. Based on the semi-automated or fully-automated sowing of crop plants on a cultivation area by agricultural machinery, normally seeds of crop plants are arranged in lines or rows, such that the growth of the crop plants can be efficiently monitored, the treatment of crop plants can be efficiently provided, and the harvest of the crop plants can be precisely predetermined. Beside the specific place at which the crop plant is planted, an area is provided directly neighbored to the specific place, in which the roots of the crop plants can spread. This root spreading area is also included in the term crop planting row, wherein special care has to be taken on this area, because any influence, e.g. mechanical, biological, or chemical, on this area affects the growth and the health of the crop plant. Between two adjacent crop planting rows an intermediate area respectively row is provided, which has not any effect or solely a minor effect on the growth and the health of the crop plant. Therefore, minor care has to be taken on this intermediate areas.

Image data used herein is to be understood broadly in the present case and comprises any data or electromagnetic radiant imagery that may be obtained or generated by one camera, one image sensor, a plurality of cameras or a plurality of image sensors. Image data are not limited to the visible spectral range and to two dimensionalities. Thereby, also cameras obtaining image data in e.g. the infrared spectral range are included in the term image data. The frame rate of the camera may be in the range of 0.3 Hz to 48 Hz, but is not limited thereto.

The term distance used herein is to be understood broadly in the present case and represents a length of the shortest connection between two objects or points. The distance includes but is not limited to the Euclidean distance or geodesic distance. A dynamic distance, in particular a dynamic minimal distance, may be a distance being preset, pre-determined, pre-calculated or calculated/determined/set online/on fly. The dynamic minimal distance is a dynamic distance indicating a dynamic minimal threshold or dynamic threshold around the crop plant, in which no first and/or second crop protection product is allowed to be applied. The dynamic threshold around the crop within the row is not static but adjusted in a dynamic manner as a function of active ingredient parameter, an application configuration parameter, a crop parameter, a weed parameter and an environment and microclimatic condition parameter. The dynamic threshold may have a circular or eliptic form, but is not limited thereto. The active ingredient parameter, the application configuration parameter, the crop parameter, the weed parameter and/or the environment and microclimatic condition parameter can either be set prior to the treatment or online during the treatment if e.g. environmental or microclimatic or crop stages or any other parameter vary on sub-areas of the treated field. The active ingredient parameter may classify the herbicide into non-selective/selective (e.g. intrinsic selectivity, crop trait, presence of safener) herbicide, the systemic/non-systemic (e.g. contact) herbicide, the soil mobility, the crop residue management and/or the potency of the formulated active ingredient (formulation type, adjuvant system used) for classifying the used herbicide into selective and non-selective herbicides, wherein a non-selective herbicide is further selected, in particular divided or differentiated, in contact and systemic herbicides. Application configuration parameter may represent the size of the droplets. Fine droplets, medium droplets or coarse droplets are determined based on information about the nozzle type, the droplet size distribution, the kinetic energy of droplets, the application speed, the water volume, the boom height and level of boom stabilization, the nozzle configuration (e.g. vertical or angled) and/or the sprayer configuration (e g air assisted sprayer, drone), but is not limited thereto. The crop parameter may represent a difficult target or an easy target. The difficult target or easy target are determined based on information about the crop species, the sensitivity of crop (e.g. phytotoxicity risk), the crop architecture (e.g. above and below ground), the crop stage (e.g. pre-emergence or post-emergence), the hydrophobicity of crop (e.g. wettability properties of crop), the health status of crop (e.g. abiotic or biotic stress) and/or the crop tolerance (e.g. traits), but is not limited thereto. The crop stage include that at pre-emergence (i.e. before crop is emerged and green parts are visible) different herbicides can be used selectively relative to post-emergence and different threshold settings are required or appropriate. The weed parameter may represent a weed target. The weed target is determined based on information about the weed species, the weed architecture, the weed threshold, the weed stage and/or the resistance level against specific active ingredients, but is not limited thereto. The environmental and microclimatic conditions parameter may represent favorable spray conditions and unfavorable spray conditions. The favorable spray conditions and unfavorable spray conditions are determined based on information about the wind speed, the temperature, the relative humidity, the soil moisture, the soil temperature, possible temperature inversions and/or the presence or absence of dew, but is not limited thereto. The threshold may be provided in a plurality of classes, wherein each class indicates a specific distance, in particular a radius, to the crop in centimeter, cm. Exemplary, threshold class 0 is 0 cm, threshold classes 1 to 4 are 0.01 to 1.5 cm, threshold classes 5 to 9 are 1.51 to 3 cm, threshold classes 10 and 11 are 3.01 and 4.0 cm, and threshold classes 12 to 13 are >4.01 cm. The dynamic distance may be determined by considering first the active ingredient parameter, than the crop parameter, than the weed parameter, than the application configuration parameter and finally the environmental and microclimate condition parameter.

The application unit is to be understood broadly in the present case and comprises any device configured to apply a crop protection product onto a crop plant and/or a weed plant. The application unit may be an elastic arm, a robotic arm, in particular a single- or multi-articulated robot arm, or a stiff arm at which at least one outlet of the crop protection product is arranged, but is not limited thereto. The outlet of the crop protection product may be a spot spray equipment or broad band spray equipment. The application unit may be arranged on the application device. In case of an application of a plurality of different crop protection products, the application unit may comprise a plurality of different tanks and different outlets for each individual crop protection product, wherein each of the different tanks and the different outlets can be arranged on a separate arm. Furthermore, the different application units, i.e. the respective functionality, according to the present disclosure, e.g. the first, second and third application unit, may be provided by only one application unit, e.g. by means of only one sprayer, i.e. by using only one fluid path for the crop protection products, as long as the respective crop protection product can be applied according to the present disclosure.

The application device is to be understood broadly in the present case and comprises any device being configured to apply a crop protection product onto an agricultural field. The application device may be configured to traverse the agricultural field. The application device may be a ground or an air vehicle, e.g. a tractor-mounted vehicle, a self-propelled sprayer, a rail vehicle, a robot, an aircraft, an unmanned aerial vehicle (UAV), a drone, or the like. The application device may be equipped with one or more application unit(s).

The system as used herein refers to a device being arranged on, at or in the application device. The system may be configured to collect image data via the receiving unit or to process image data provided from an external source. The system may comprise a first, second, third providing unit, a first application unit, and a second application unit, wherein the system is configured to provide the collected/provided image data from the receiving unit to a first providing unit, to provide the model results of the first providing unit to the second providing unit and third providing unit, and provide the respective model results of the second providing unit and third providing unit to the first application unit and second application unit.

The receiving unit is to be understood broadly in the present case and comprises any device which receives data, in particular image data, from external components, e.g. cameras being arranged space apart from the receiving unit. Transmission of respective data may be provided by wire or wireless connection. Further, the term receiving unit also comprises any device which obtains, provides, assembles or produces data, in particular image data, by itself. Therefore, the receiving unit may be a camera but is not limited thereto.

The crop planting row identification model as used herein refers to a model which is configured to identify crop planting rows in the image data of at least one part of the agricultural field. The crop planting row identification model is configured to identify crop planting rows by image analysis, in particular digital image processing including algorithms for providing a classification, a feature extraction, a multiscale-signal analysis, a pattern recognition, and a projection, but is not limited thereto. Further, the crop planting row identification model may be provided as one or more machine learning algorithms. The crop planting row information can also be provided by specific sowing devices.

The weed plant detection model as used herein refers to a model which is configured to detect weed plants between and within the crop planting rows identified by the crop planting row identification model. The weed plant detection model is configured to detect the weed plants between the crop planting rows by image analysis, in particular digital image processing including algorithms for providing a classification, a feature extraction, a multiscale-signal analyzes, a pattern recognition, and a projection, but is not limited thereto. Further, the weed plant detection model may be provided as one or more machine learning algorithms. Furthermore, the weed plant detection model may be configured to classify the detected weed plants and its growth stages by classification methods. Classification methods may be manual, automatic, numerical, non-numerical, statistical, distribution-free, monitored, non-monitored, parametrical, and non-parametrical methods provided as algorithms but are not limited thereto. The classification may be calculated by a classification unit.

The crop and weed detection model as used herein refers to a model which is configured to detect crop plants and weed plants in the crop planting rows identified by the crop planting row identification model. The crop and weed plant detection model is configured to detect the crop plants and the weed plants in the crop planting rows by image analysis, in particular digital image processing including algorithms for providing a classification, a feature extraction, a multiscale-signal analysis, a pattern recognition, and a projection, but is not limited thereto. Further, the crop and weed plant detection model may be provided as one or more machine learning algorithms. Furthermore, the crop and weed identification model may be configured to classify the detected weed plants by classification methods. Classification methods may be manual, automatic, numerical, non-numerical, statistical, distribution-free, monitored, non-monitored, parametrical, and non-parametrical methods provided as algorithms but are not limited thereto. The classification may be calculated by a classification unit.

The first providing unit as used herein refers to a subsystem of the system including the crop planting row identification model. The first providing unit is configured to receive image data from the receiving unit as an input and to transmit identification data of the crop planting rows, provided by the crop planting row identification model, to the second providing unit and third providing unit. Transmission of respective data may be provided by wire or wireless connection.

The second providing unit as used herein refers to a subsystem of the system including the weed plant detection model. The second providing unit is configured to receive the data identifying the crop planting rows of the first providing unit as an input and to transmit detection data of weed plants between the identified crop planting rows to the first application unit. Further, the second providing unit may be configured to provide/establish an instruction including information with respect to volume/amount and duration of the application of crop protecting products on the weed plants between the identified crop planting rows and to transmit the instruction to the first application unit. Transmission of respective data may be provided by wire or wireless connection.

The third providing unit as used herein refers to a subsystem of the system including the crop and weed detection model. The third providing unit is configured to receive the data identifying the crop planting rows of the first providing unit as an input and to transmit detection data of weed plants in the identified crop planting rows to the second application unit. Further, the third providing unit may be configured to determine the distance between the crop plants and weed plants in the identified crop planting rows by photogrammetry or the like. Furthermore, the third providing unit may be configured to provide/establish an instruction including information with respect to volume/amount, duration and enabling of the application of crop protecting products on the weed plants in the identified crop planting rows to the second application unit. Transmission of respective data may be provided by wire or wireless connection.

The control data as used herein is to be understood broadly in the present case and relates to any data configured to operate and control the application device. The control data are provided by a control unit and may be configured to control one or more technical means of the application device, e.g. the drive control of the application device, and to control the application of crop protecting products but is not limited thereto.

Optionally, the method for selectively applying at least one crop protection product, in particular herbicides, onto an agricultural field, comprises the steps of applying a first crop protection product onto a weed plant detected between the identified crop planting rows, if a distance between the weed plant and an adjacent crop plant is larger than a first dynamic determined minimal distance; and applying the first crop protection product onto a weed plant detected in the identified crop planting rows, if a distance between the weed plant and an adjacent crop plant is larger than a second dynamic determined minimal distance, wherein the first dynamic determined minimal distance and the second dynamic determined minimal distance are identical or different.

Optionally, the system for selectively applying at least one crop protection product onto an agricultural field, comprises a first application unit configured to apply a first crop protection product onto a weed plant detected between the identified crop planting rows, if a distance between the weed plant and an adjacent crop plant is larger than a first dynamic determined minimal distance; and a second application unit configured to apply the first crop protection product onto a weed plant detected in the identified crop planting rows, if a distance between the weed plant and an adjacent crop plant is larger than a second dynamic determined minimal distance, wherein the first dynamic determined minimal distance and the second dynamic determined minimal distance are identical or different.

In an embodiment the method for selectively applying at least one crop protection product onto an agricultural field further comprises the step of applying a second crop protection product onto a weed plant detected in the identified crop planting rows, if a distance between the weed plant and an adjacent crop plant is less than the dynamic distance. The application of the second crop protection product enables a separate application of another crop protection product being different to the first crop protection product or an application of a combination of the first and second crop protection product onto a weed plant detected in the identified crop planting rows, when the distance between the weed plant and the adjacent crop land is less than a dynamic distance, i.e. when the weed plant is detected in the root spreading area of the crop plants. Since special care has to be taken on this area, because any influence, e.g. mechanical, biological, or chemical, on this area affects the growth and the health of the crop plant, a crop protection product non-affecting or slightly affecting the crop plants can be used, e.g. a selective herbicide, in the root spreading area of the crop plants. Therefore, the protection of crop plants on an agricultural field can be improved.

In a further embodiment of the method for selectively applying at least one crop protection product onto an agricultural field, the weed plant detection model and/or the crop and weed detection model are further configured to classify the detected weed plants. Classification of the detected weeds leads to a specific treatment of specific weed plants with respect to the selection of the specific crop protection product and/or the volume/amount and duration of the application of crop protection products. Further, the classification of the detected weeds leads to the possibility of statistical and regional evaluation of the weed infestation such that the degree of weed infestation can be estimated or predicted in an improved manner for future growing seasons. This enables that growers or farmers can order/buy crop protection products timely and in sufficient quantity such that rapid intervention in case of the detection of weed infestation is made possible. Therefore, the protection of crop plants on an agricultural field can be improved.

In another embodiment of the method for selectively applying at least one crop protection product onto an agricultural field, the first crop protection product is a non-selective herbicide and the second crop protection product is a selective herbicide. The application of non-selective herbicides onto the weed detected between the identified crop planting rows enables an efficient reduction and prevention of weed plants in area which does not affect the growth and the health of the crop plant. Therefore, uncontrolled plant growth of weed plants in the area between the identified crop planting rows can be prevented or reduced. The application of selective herbicides detected in the crop planting rows enables that only weed plants are treated in the crop planting rows and that crop injury can be efficiently prevented.

In a further embodiment of the method for selectively applying at least one crop protection product onto an agricultural field, the image data is acquired by means of an application device for a crop protection product and/or an airborne device. The acquirement of image data directly at the application device enables a prompt application of crop protecting products on the detected weed plants, such that the frequency of working steps on the agricultural fields can be reduced. Therefore, the stress caused by the agricultural machinery on the crop plants and the arable soil can be efficiently reduced and the costs of the whole crop planting, growing and harvesting procedure can be significantly reduced. The acquirement of image data not directly at the application device, e.g. by an airborne device, enables that the volume/amount of crop protecting products can be pre-determined or estimated and that specific regions being infested by weed plants can be identified. Therefore, unnecessary uses of agricultural machinery on the agricultural fields can be prevented such that the stress caused by the agricultural machinery on the crop plants and the compaction of arable soil can be efficiently reduced and the costs of the whole crop planting, growing and harvesting procedure can be reduced.

In a further embodiment of the method for selectively applying at least one crop protection product onto an agricultural field, around a crop planting row, a safety distance is provided. The safety distance enables or ensures that herbicides, in particular non-selective herbicides, are not erroneously applied on crop plants. Thereby, crop injury or stunting, crop failure or crop shortfall can be efficiently prevented.

In a further embodiment of the method for selectively applying at least one crop protection product onto an agricultural field, the first crop protection product is applied by a first application device and the second crop protection product is applied by a second application device. The separation of the application of the first crop protection product by a first application device and the second crop protection product by a second application device enables an improved application of crop protection products on weed plant because each application device can be configured to identify one or more specific weed plants and to apply respective one or more specific crop protection products.

In a further embodiment of the method for selectively applying at least one crop protection product onto an agricultural field further comprises the step of providing control data for at least one application device for selectively applying at least the first crop protection product, preferably for selectively applying the first crop protection product and the second crop protection product. The providing of control data enables a semi-automatic or fully automatic control of the application device, wherein the control data e.g. includes the drive control and the control of application of crop protection products. Thereby, man power and costs can be reduced and the degree of automation on the agricultural fields can be increased.

In an embodiment of the application device, the application device is a sprayer comprising a spot spray equipment. Using spot spray equipment enables a targeted and/or precise/ultra-precise application of specific crop protection products on weed plants. Therefore, weed plants growing directly in contact with the crop plants, growing nearby the crop plants or growing in the root spreading area can be treated, wherein the treatment of the crop plants will be left out such that the protection of crop plants on an agricultural field can be improved and crop injury can be prevented.

### BRIEF DESCRIPTION OF THE DRAWINGS

In the following, the present disclosure is further described with reference to the enclosed figures:

FIG. 1 illustrates a flow diagram of a computer-implemented method for selectively applying at least one crop protection product onto an agricultural field;

FIG. 2 illustrates a flow diagram of a further computer-implemented method for selectively applying at least one crop protection product onto an agricultural field of FIG. 1;

FIG. 3 illustrates a flow diagram of a further computer-implemented method for selectively applying at least one crop protection product onto an agricultural field of FIG. 2;

FIG. 4 is a schematic illustration of an application unit applying crop protection products onto weed plants on the agricultural field;

FIG. 5 is a schematic illustration of another application unit applying crop protection products onto weed plants on the agricultural field of FIG. 4;

FIG. 6 illustrates a block diagram of an example system architecture of a system for selectively applying at least one crop protection product onto an agricultural field;

FIG. 7 illustrates another block diagram of an example system architecture of a system for selectively applying at least one crop protection product onto an agricultural field of FIG. 6;

FIG. 8 illustrates another block diagram of an example system architecture of a system for selectively applying at least one crop protection product onto an agricultural field of FIG. 7;

FIG. 9 illustrates a decision tree for providing the dynamic distance, in particular the dynamic threshold.

### DETAILED DESCRIPTION OF EMBODIMENT

The disclosure is based on the protection of crop plants from adverse effects from weed plants such as detracting nutritive substances which are intended for the growth of the crop plants. The weed plants are distributed heterogeneously over the entire agricultural field such that the distribution of weed plants on the agricultural field are not constant and therefore not completely known before the application device treats the agricultural field. By detecting crop plants and weed plants in the crop planting rows, by detecting weed plants between the crop planting rows and by applying crop protection products onto the detected weed plants, a protection of the crop plants can be reached. This advantageous information about this protection of crop plants serves as the basis of an improved treatment strategy and hence the reduction of harvest losses.

The following embodiments are examples for implementing the method, the system or application device disclosed herein and shall not be considered limiting.

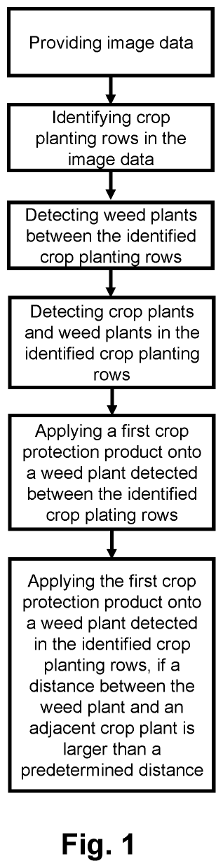

FIG. 1 illustrates an exemplarily embodiment of a computer-implemented method for selectively applying at least one crop protection product onto an agricultural field. In the following, an exemplary order of the steps according to the present disclosure is explained. However, the provided order is not mandatory, i.e. all or several steps may be performed in a different order or simultaneously.

The method steps shown in FIG. 1 may be executed by the systems.

In a first step, image data of at least a part of an agricultural field which is to be treated with a crop protection product are provided by at least one external, i.e. cameras arranged on a separate device different to the application device, or internal, i.e. application device is equipped with a camers, camera of the application device, which camera are not limited to the visible spectral range and two dimensionalities, and are received by receiving unit of the systems. The receiving unit provides the image data for processing in further methods steps to the system. The at least one external or internal camera or image sensor is configured to transmit the provided image data wireless or by wire to the receiving unit of the system. The image data may for instance be provided in the file format .jng, .img. .pic, .png, .jpg but is not limited thereto.

In a second step, crop planting rows are identified in the received image data of the at least one part of the agriculture field by a crop planting row identification model in the first providing unit. The first providing unit receives the image data from the receiving unit, uses the image data for identification of the crop planting rows, and provides identification information of the crop planting rows to the system for further processing. The crop planting row identification model identifies the crop planting rows on basis of image analysis, in particular digital image processing including e.g. algorithms for providing a classification, a feature extraction, a multiscale-signal analysis, a pattern recognition, and a projection. In another embodiment, the crop planting row identification model may be provided as one or more machine learning algorithms.

In a third step, weed plants are detected between the identified crop planting rows by a weed plant detection model in the second providing unit. The second providing unit receives the identification information from the first providing unit, uses this information/identification of the crop planting rows in order to detect weed plants between the identified crop planting rows, and provides weed information for the non-crop planting row areas to the system for further processing. The weed plant detection model detects weed plants on the basis of image analysis, in particular digital image processing e.g. including algorithms for providing a classification, a feature extraction, a multiscale-signal analysis, a pattern recognition, and a projection. In another embodiment, the weed plant detection model may be provided as one or more machine learning algorithms.

In a fourth step, crop plants and weed plants are detected in the identified crop planting rows by a crop and weed detection model in the third providing unit. The third providing unit receives the identification information from the first providing unit, uses this information/identification of the crop planting rows in order to detect crop plants and weed plants in the identified crop planting rows, and provides crop and weed information for the crop planting rows to the system for further processing. The crop and weed detection model detects crop plants and weed plants on the basis of image analyzes, in particular digital image processing e.g. including algorithms for providing a classification, a feature extraction, a multiscale-signal analysis, a pattern recognition, and a projection. In another embodiment, the crop and weed plant detection model may be provided as one or more machine learning algorithms.

In a fifth step, a first crop protection product is applied onto the weed plants detected between the identified crop planting rows by a first application unit. The first application unit receives the weed information of the non-crop planting row areas as established in the third step and uses this information for release an application of the first crop protection product being e.g. non-selective herbicide onto detected weed plant between the identified crop planting rows. The release of the application of the first crop protection product may be provided electrically or mechanically in order to open at least one outlet of the crop protection product at the first application unit.

In a sixth step, the first crop protection product is applied onto the weed plants detected in the identified crop planting rows by a second application unit, if distance between the weed and an adjacent crop plant is larger than a dynamic distance. The second application unit receives the crop and weed information of the crop planting rows as established in the fourth step and uses this information for release of an application of the first crop protection product being e.g. non-selective herbicide onto detected weed plants in the identified crop planting rows in case the distance between the weed plant and an adjacent crop plant is larger than a dynamic distance. The distance is determined by the third providing unit by photogrammetry or the like. The release of the application of the first crop protection product may be provided electrically or mechanically in order to open at least one outlet of the crop protection product at the second application unit. In case the distance between the weed plant and an adjacent crop plant is not larger than a dynamic distance, the release of an application of the first crop protection product on this specific weed plants is refused, such that these weed plants will be omitted on the field in order to prevent the harvest loss by killing the weed plant and by killing or injuring the crop plant. The dynamic distance is provided by a function considering an active ingredient parameter, an application configuration parameter, a crop parameter, a weed parameter and an environment and microclimatic condition parameter.

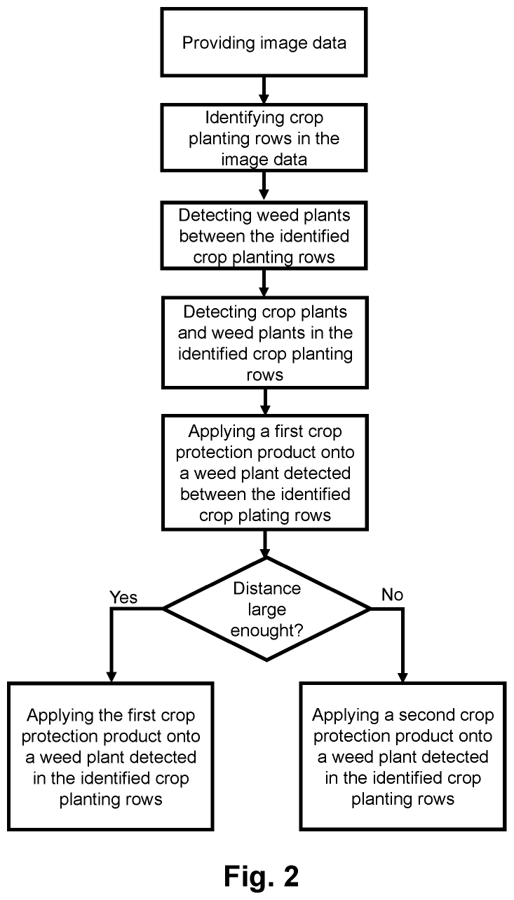

FIG. 2 illustrates a flow diagram of a further embodiment of the computer-implemented method for selectively applying at least one crop protection product onto an agricultural field of FIG. 1.

Beside the steps one to six of FIG. 1, the further embodiment of the computer implemented method as depicted in FIG. 2 comprises a further step for replacing the second alternative of the sixth step, i.e. omitting weed plants when the distance between the weed plant and an adjacent crop plant is not larger than a dynamic distance, of FIG. 1. The further embodiment of the computer-implemented method comprises the further step of applying a second crop protection product onto a weed plant which is detected in the identified crop planting rows, if the distance between the weed plant and an adjacent crop plant is less than the dynamic distance. The second crop protection product is a selective herbicide such that a control of the weed plants can be provided while the crop plants remain on the agricultural field.

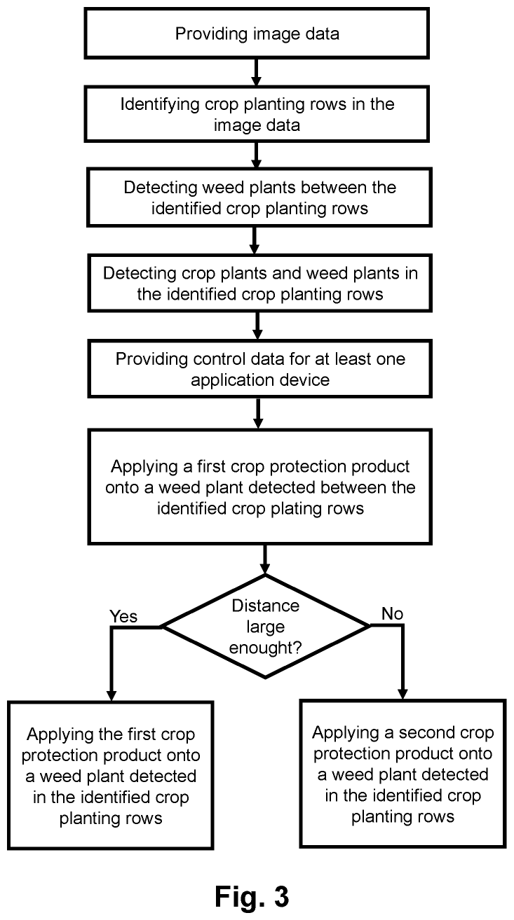

FIG. 3 illustrates a flow diagram of a further embodiment of the computer-implemented method for selectively applying at least one crop protection product onto an agricultural field of FIG. 2.

Besides the steps one to six of FIG. 2, the further embodiment of the computer implemented method as depicted in FIG. 1 comprises a further step of providing control data to control unit of the system in order to control at least one application device. The control data may be configured to control one or more technical means of the application device, e.g. the drive control of the application device or movement of the application units, and to control the application of crop protecting products.

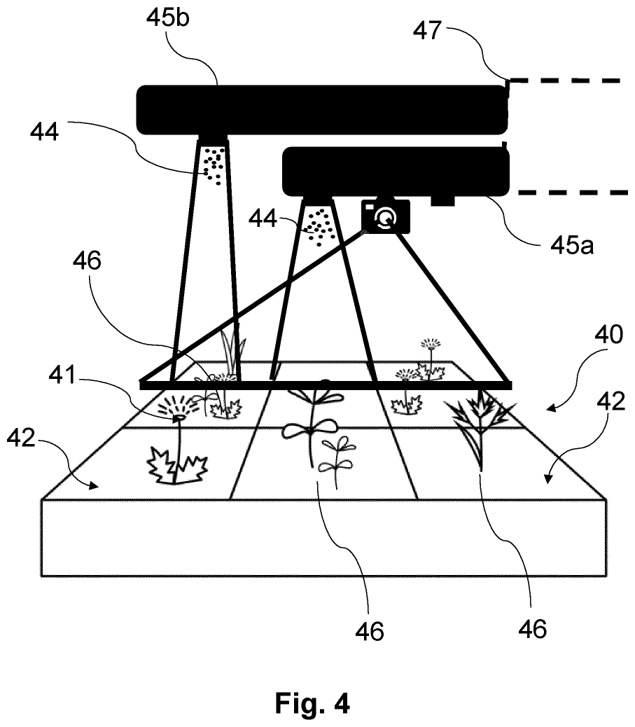

FIG. 4 is a schematic illustration of an application device applying crop protection products onto weed plants on the agricultural field.

An application device 47 comprises a first application unit 45a and a second application unit 45b, wherein the first and second application unit 45a and 45b are directly mounted or coupled to the application device 47. The first application unit 45a includes a camera for providing image data of the at least one part of an agricultural field 40. The camera or a plurality of cameras is arranged directly at or on the first application unit 45a. In another embodiment, the camera or plurality of cameras can be also arranged directly at or on the first application unit 45b or at or on the application device 47. The first and second application unit 45a and 45b comprise at least one outlet for applying crop protection products 44 onto the agricultural field 40. The agricultural field 40 comprises crop planting rows 42 and areas between the crop planting rows 42. Within the crop planting rows 42, crop plants 41 are arranged in a line or row, wherein, beside the crop plants 41, weed plants 46 can exist and grow in an heterogeneous manner. Weed plants 46 can also exist and grow in a heterogeneous manner out of the crop planting rows 42, i.e. in the areas between the crop planting rows. The first application unit 45a applies the first crop protection products 44 on the areas between the crop planting rows and the second application unit 45b applies the first crop protection products 44 on the crop planting rows 42.

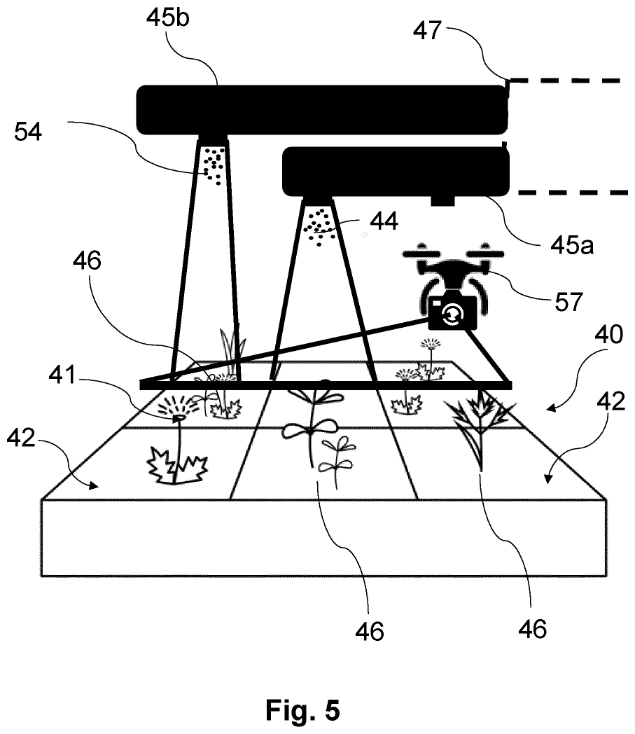

FIG. 5 is a schematic illustration of another application device applying crop protection products onto weed plants on the agricultural field of FIG. 4.

In contrast the features as depicted in FIG. 4, the arrangement of the camera or the plurality of cameras is different. The camera or the plurality of cameras as depicted in FIG. 5 are arranged directly at or on an airborne device 57, in particular a drone or the like. The airborne device 57 can be controlled or operated in a non-autonomous or autonomous manner. Further, the airborne device 57 comprises a transmitting unit for transmitting the provided image data to the application device 47 by visiting a docking station at the application device or by a wireless connection. The airborne device 57 is configured to provide the image data of at least a part of an agricultural field directly at the application device 47, directly in front of the application device 47 or far ahead the application device.

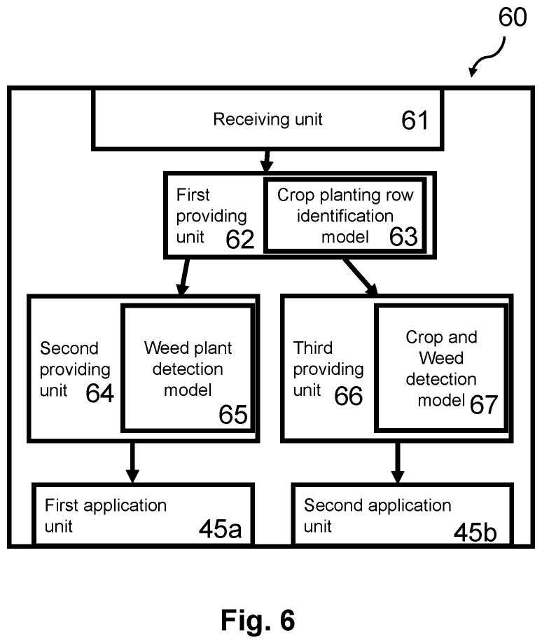

FIG. 6 illustrates a block diagram of an example system architecture of a system for selectively applying at least one crop protection product onto an agricultural field.

The system 60 comprises a receiving unit 61 for receiving image data wireless or by wire from a camera. The receiving unit 61 provides the image data for processing to the system 60. The system 60 further comprises a first providing unit 62 including the crop planting row identification model 63. The first providing unit 62 receives the image data wireless or by wire from the receiving unit 61, uses the image data for identification of the crop planting rows, and provides identification information of the crop planting rows to the system. The system 60 further comprises a second providing unit 64 including the weed plant detection model 65. The second providing unit 64 receives the identification information of the crop planting rows wireless or by wire from the first providing unit 62, uses this information/identification of the crop planting rows in order to detect weed plants between the identified crop planting rows, and provides weed information for the non-crop planting row areas to the system. The system 60 further comprises a third providing unit 66 including a crop and weed detection model 67. The third providing unit 66 receives the identification information wireless or by wire from the first providing unit 62, uses this information/identification of the crop planting rows in the crop and weed detection model in order to detect crop plants and weed plants in the identified crop planting rows, and provides crop and weed information for the crop planting rows to the system. The system 60 further comprises a first application unit 45a. The first application unit 45a receives the weed information of the non-crop planting row areas wireless or by wire from the second providing unit 64. The system 60 further comprises a second application unit 45b. The second application unit 45b receives the crop and weed information of the crop planting rows wireless or by wire from the third providing unit 64.

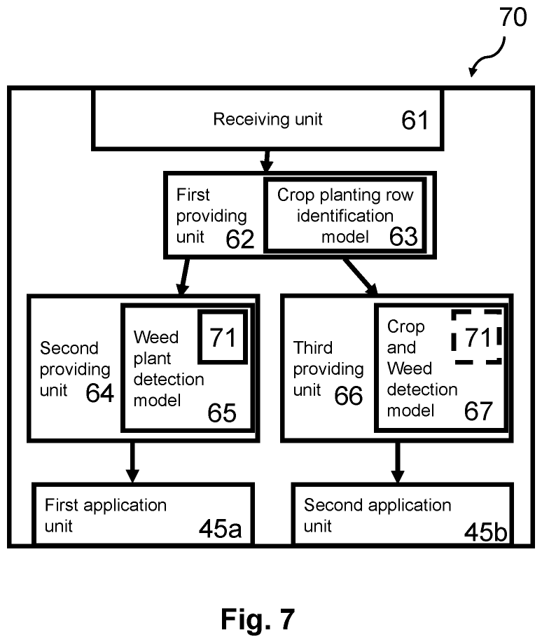

FIG. 7 illustrates another block diagram of an example system architecture of a system for selectively applying at least one crop protection product onto an agricultural field of FIG. 6.

Beside all units of the system 60 as depicted in FIG. 6, the system 70 as depicted in FIG. 7 further comprises a classification unit 71. The classification unit 71 is arranged or integrated in the weed plant detection model 65 and/or in the crop and weed detection model 67 for classifying the detected weed plants.

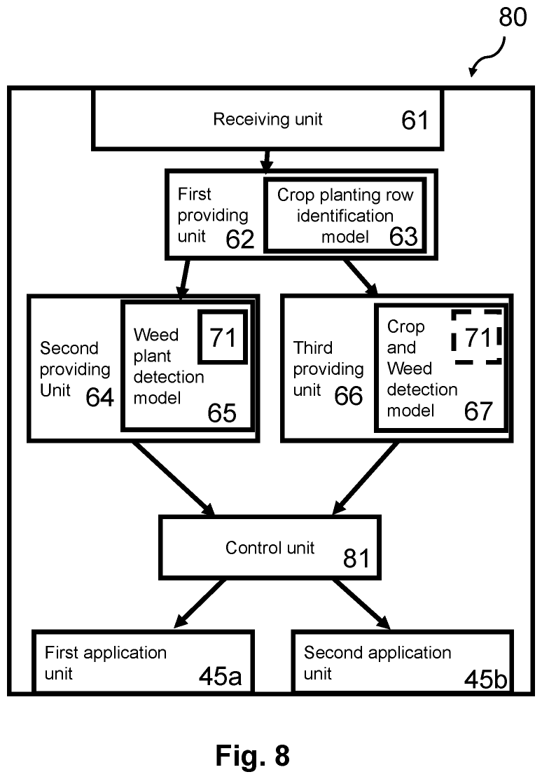

FIG. 8 illustrates another block diagram of an example system architecture of a system for selectively applying at least one crop protection product onto an agricultural field of FIG. 7.

Beside all units of the system 70 as depicted in FIG. 7, the system 80 as depicted in FIG. 8 further comprises a control unit 81. The control unit 81 receives the weed information of the non-crop planting row areas wireless or by wire from the second providing unit 64 and/or the crop and weed information of the crop planting rows wireless or by wire from the third providing unit 64 and uses this information in order to provide control data for controlling the application device. The control unit 81 transmits control data to the first application unit 45a and/or the second application unit 45b in order to control the application of at least one crop protection product onto an agricultural field. Also the control unit 81 may be configured to control the drive of the application device.

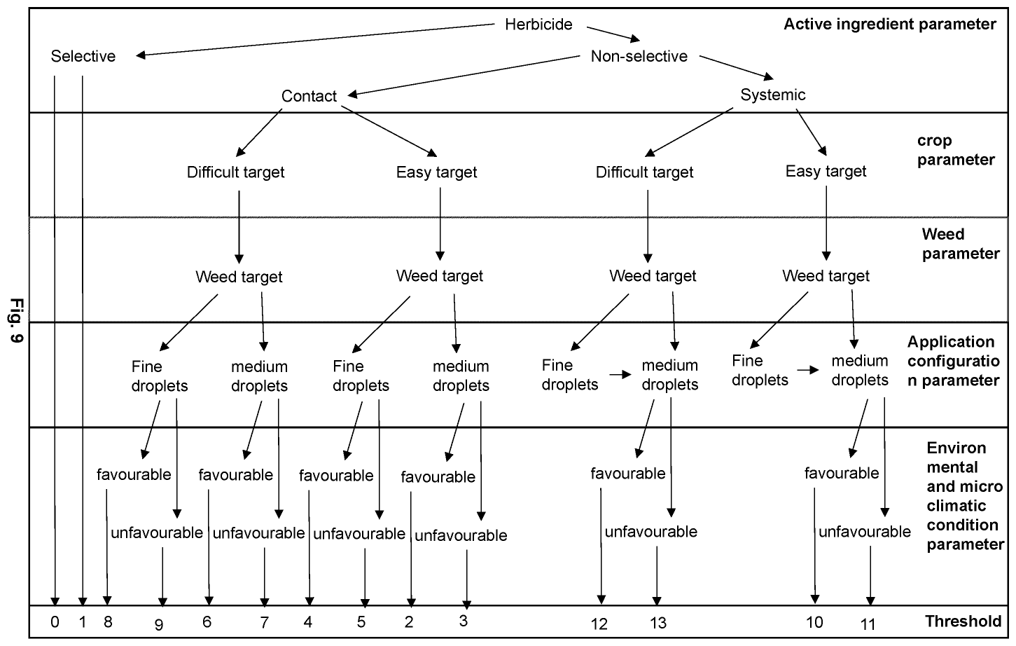

FIG. 9 illustrates a decision tree for providing the dynamic distance, in particular the dynamic threshold.

The decision tree for providing the dynamic distance, in particular the dynamic threshold starts with considering the active ingredient parameter. Within the active ingredient parameter a classification of the herbicide is made into a selective or non-selective herbicide. In case the herbicide is classified as to be a selective herbicide, threshold classes 0 and 1 can be chosen. Threshold class 0 equals 0 cm, i.e. an application directly on the crop plant is possible. The threshold class 1-4 equals to a range of 0.01 cm to 1.5 cm in which no first and/or second crop protection product is allowed to be applied. In case the herbicide is classified as to be a non-selective herbicide, the non-selective herbicide is further classified into a contact herbicide and a systemic herbicide. After classifying the herbicide into a contact or systemic herbicide, the crop parameter, the weed parameter, the application configuration parameter and the environmental and micro climate condition parameter are considered. The crop parameter represents respectively classifies the crop into a difficult target or an easy target. The weed parameter represents respectively classifies the weed into a weed target. The application configuration parameter represents respectively classifies the application configuration into fine droplets, medium droplets or coarse droplets. The environmental and microclimate condition parameter represents respectively classifies the condition into favorable spray condition and unfavorable spray condition. In case the non-selective herbicide is a contact herbicide, the crop parameter is a difficult target, the weed parameter is a weed target, the application configuration parameter is a fine droplet, and the environmental and microclimate condition parameter is a favorable spray condition, the threshold class 4-9 is chosen. The threshold class 4 to 9 equals to a range on 1.51 cm to 3 cm in which no first and/or second crop protection product is allowed to be applied. In case the non-selective herbicide is a contact herbicide, the crop parameter is a difficult target, the weed parameter is a weed target, the application configuration parameter is a fine droplet, and the environmental and microclimate condition parameter is an unfavorable spray condition, the threshold class 4-9 is chosen. The threshold class 4-9 equals to a range on 1.51 cm to 3 cm in which no first and/or second crop protection product is allowed to be applied. In case the non-selective herbicide is a contact herbicide, the crop parameter is a difficult target, the weed parameter is a weed target, the application configuration parameter is a medium droplet, and the environmental and microclimate condition parameter is a favorable spray condition, the threshold class 4-9 is chosen. The threshold class 4-9 equals to a range on 1.51 cm to 3 cm in which no first and/or second crop protection product is allowed to be applied. In case the non-selective herbicide is a contact herbicide, the crop parameter is a difficult target, the weed parameter is a weed target, the application configuration parameter is a medium or coarse droplet, and the environmental and microclimate condition parameter is an unfavorable spray condition, the threshold class 4-9 is chosen. The threshold class 4-9 equals to a range of 1.51 cm to 3 cm in which no first and/or second crop protection product is allowed to be applied. In case the non-selective herbicide is a contact herbicide, the crop parameter is an easy target, the weed parameter is a weed target, the application configuration parameter is a fine droplet, and the environmental and microclimate condition parameter is a favorable spray condition, the threshold class 4-9 is chosen. The threshold class 4-9 equals to a range on 1.51 cm to 3 cm in which no first and/or second crop protection product is allowed to be applied. In case the non-selective herbicide is a contact herbicide, the crop parameter is an easy target, the weed parameter is a weed target, the application configuration parameter is a fine droplet, and the environmental and microclimate condition parameter is an unfavorable spray condition, the threshold class 4-9 is chosen. The threshold class 4-9 equals to a range on 1.51 cm to 3 cm in which no first and/or second crop protection product is allowed to be applied. In case the non-selective herbicide is a contact herbicide, the crop parameter is an easy target, the weed parameter is a weed target, the application configuration parameter is a medium droplet, and the environmental and microclimate condition parameter is a favorable spray condition, the threshold class 1-3 is chosen. The threshold class 1-3 equals to a range on 0.01 cm to 1.5 cm in which no first and/or second crop protection product is allowed to be applied. In case the non-selective herbicide is a contact herbicide, the crop parameter is an easy target, the weed parameter is a weed target, the application configuration parameter is a medium droplet, and the environmental and microclimate condition parameter is an unfavorable spray condition, the threshold class 1-3 is chosen. The threshold class 1-3 equals to a range on 0.01 cm to 1.5 cm in which no first and/or second crop protection product is allowed to be applied. In case the non-selective herbicide is a systemic herbicide, the crop parameter is a difficult target, the weed parameter is a weed target, the application configuration parameter is a fine droplet and/or medium droplet, and the environmental and microclimate condition parameter is a favorable spray condition, the threshold class 12-13 is chosen. The threshold class 12-13 equals to a range on >4.01 cm in which no first and/or second crop protection product is allowed to be applied. In case the non-selective herbicide is a systemic herbicide, the crop parameter is a difficult target, the weed parameter is a weed target, the application configuration parameter is a fine droplet and/or medium droplet, and the environmental and microclimate condition parameter is an unfavorable spray condition, the threshold class 12-13 is chosen. The threshold class 12-13 equals to >4.01 cm in which no first and/or second crop protection product is allowed to be applied. In case the non-selective herbicide is a systemic herbicide, the crop parameter is an easy target, the weed parameter is a weed target, the application configuration parameter is a fine droplet and/or medium droplet, and the environmental and microclimate condition parameter is a favorable spray condition, the threshold class 10-11 is chosen. The threshold class 10-11 equals to a range on 3.01 cm to 4 cm in which no first and/or second crop protection product is allowed to be applied. In case the non-selective herbicide is a systemic herbicide, the crop parameter is an easy target, the weed parameter is a weed target, the application configuration parameter is a fine droplet and/or medium droplet, and the environmental and microclimate condition parameter is an unfavorable spray condition, the threshold class 10-11 is chosen. The threshold class 10-11 equals to a range on 3.01 cm to 4 cm in which no first and/or second crop protection product is allowed to be applied. The threshold 0 means that there is no threshold. The threshold 1-3 means a very low threshold. The threshold 4-9 means a low threshold. The threshold 10-11 means a moderate threshold. The threshold 4-9 means a large threshold.

### Example for Providing the Dynamic Minimal Distance (Threshold) for Glufosinate-Ammonium:

Glufosinate-ammonium is used in herbicide-tolerant soybeans in early post-emergence. Since glufosinate-ammonium is selective in herbicide-tolerant soybeans, no threshold need to be applied (threshold=0 cm). In case glufosinate-ammonium is applied in non-herbicide tolerant corn, it acts as a non-selective herbicide with some systemic activity. Depending on the crop and weed parameter (e.g. easy to control small broadleaf weeds) and glufosinate-ammonium will be applied with a nozzle causing fine droplets (e.g. TP65002E) or a nozzle causing medium to coarse droplets (e.g. air induction nozzle) as application conditions, different tresholds need to be applied, e.g. 3 cm (low threshold) vs. 1.9 cm (low threshold)

### Example for Providing the Dynamic Minimal Distance (Threshold) for Glyphosate:

Glyphosate is a non-selective systemic herbicide. This is represented by the active ingredient parameter. As example, Glyphosate is used in non-herbicide-tolerant corn at late post emergence application, i.e. under good growing conditions. E.g. to control difficult to control weeds (defined as weed parameter) at favorable environmental conditions, the defined threshold could be 3.3 cm (medium threshold).

Example for providing the dynamic minimal distance (threshold) for Diquat: Diquat is a non-selective contact herbicide which is used in e.g. perennial crop. Diquat controls small weeds. That is represented by the weed parameter in the system. When Diquat is applied on the weed, Diquat works well under cool and warm conditions. under these conditions a threshold for Diquat can be set to 1.5 cm (low threshold),

### Data for Dynamic Minimal Distance (Threshold) Setting:

Different tresholds for Glufosinate-ammonium derived in field trials (0% phytotoxicity level)

| crop | Application parameter | Threshold (cm) |
|---|---|---|
| Glufosinate-ammonium | Even air-induction | 0 cm |
| tolerant Soybean | nozzle | |
| Conventional soybean | Even air-induction nozzle | 1.9 cm |
| variety | Flat-fan nozzle (fine | 3.0 cm |
| | droplets) | |

Phytotoxicity assessment for systemic vs. less systemic herbicides derived in field trials (spot spray mode/single nozzle application) at constant teshold setting

| crop | herbicide | Phytotoxicity (%) |
|---|---|---|
| Sugar beet | Kixor | 11% |
| | Glufosinate-ammonium | 9% |

Tresholds for different herbicides derived in field trials (0% phytotoxicity level) in spot spray mode/single nozzle application (nozzle TIP 40 02 E) in mustard

| crop | herbicides | Threshold (cm) |
|---|---|---|
| mustard | Voraxor (Kixor + Tirexor), | 2.4 cm |
| | use rate 25 g/ha | |
| | Roundup Powermax II | 3.3 cm |
| | (Glyphosate), use rate | |
| | 870 g/ha | |
| | Engenia (Dicamba), use | 3.1 cm |
| | rate 560 g/ha | |
| | Liberty (Glufosinate- | |
| | ammonium), use rate | |
| | 600 g/ha | |

Tresholds derived in field trials (0% phytotoxicity level) in spot spray mode/single nozzle application in mustard

| herbicide | Application parameter | Threshold (cm) |
|---|---|---|
| Voraxor (Kixor + Tirexor), | TP 40 02 E | 2.4 cm |
| use rate 25 g/ha | | |
| | AI 65 02 E | 1.9 cm |

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the y steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A method comprising:
providing image data of at least a part of an agricultural field which is to be treated with a crop protection product;
providing a crop planting row identification model configured to identify crop planting rows in the image data of the at least the part of the agricultural field;
providing a weed plant detection model configured to detect one or more weed plants between the crop planting rows;
providing a crop and weed detection model configured to detect crop plants and the weed plants in the crop planting rows; and
applying a first crop protection product (44) onto a first weed plant of the one or more weed plants detected in the crop planting rows in response to determining a first distance between the first weed plant and an adjacent crop plant is larger than a minimal distance,
wherein the minimal distance is determined based at least in part on one or more of: an active ingredient parameter, a crop parameter, a weed parameter, an application configuration parameter, or an environmental and microclimate condition parameter.

2. The method of claim 1, further comprising applying a second crop protection product onto a second weed plant detected in the crop planting rows in response to determining a second distance between the second weed plant and an adjacent crop plant is less than the minimal distance.

3. The method of claim 2, wherein at least one of the weed plant detection model or the crop and weed detection model are further configured to classify the one or more weed plants.

4. The method of claim 2, wherein the first crop protection product (44) is a non-selective herbicide and the second crop protection product is a selective herbicide.

5. The method of claim 4, wherein the image data is acquired by one of an application device for a crop protection product or an airborne device.

6. The method of claim 2, wherein the first crop protection product is applied by a first application device and the second crop protection product is applied by a second application device.

7. The method of claim 2, wherein at least one of the crop planting rows is associated with a safety distance.

8. The method of claim 1, further comprising providing control data for at least one application device for selectively applying at least the first crop protection product.

9. A system comprising:
a receiving unit configured to receive image data of at least a part of an agricultural field to be treated with a crop protection product;
a first providing unit configured to provide a crop planting row identification model configured to identify crop planting rows in the image data of the at least the part of the agricultural field;
a second providing unit configured to provide a weed plant detection model configured to detect weed plants between the crop planting rows;
a third providing unit configured to provide a crop and weed detection model configured to detect crop plants and weed plants in the crop planting rows;
a first application unit configured to apply a first crop protection product onto a weed plant detected between the crop planting rows; and
a second application unit (45b) configured to apply the first crop protection product (44) onto a first weed plant detected in the crop planting rows in response to determining a first distance between the first weed plant and an adjacent crop plant is larger than a minimal distance,
wherein the minimal distance is determined based at least in part on one or more of: an active ingredient parameter, a crop parameter, a weed parameter, an application configuration parameter, or an environmental and microclimate condition parameter.

10. The system of claim 9, wherein the first crop protection product is applied based at least on control data.

11. The system of claim 9, wherein the first application unit comprises spot spray equipment.

12. A non-transitory computer-readable medium comprising instructions, which when executed by a processing device, cause the processing device to perform operations comprising:
providing image data of at least a part of an agricultural field which is to be treated with a crop protection product:
providing a crop planting row identification model configured to identify crop planting rows in the image data of the at least the part of the agricultural field:
providing a weed plant detection model configured to detect one or more weed plants between the crop planting rows:
providing a crop and weed detection model configured to detect crop plants and the weed plants in the crop planting rows; and
applying a first crop protection product onto a first weed plant of the one or more weed plants detected in the crop planting rows in response to determining a first distance between the first weed plant and an adjacent crop plant is larger than a minimal distance,
wherein the minimal distance is determined based at least in part on one or more of: an active ingredient parameter, a crop parameter, a weed parameter, an application configuration parameter, or an environmental and microclimate condition parameter.

13. The non-transitory computer-readable medium of claim 13, the operations further comprising applying a second crop protection product onto a second weed plant detected in the crop planting rows in response to determining a second distance between the second weed plant and an adjacent crop plant is less than the minimal distance.
